(19) United States
(12) Patent Application Publication
(10) Pub. No.: US 2024/0297535 A1
(43) Pub. Date: Sep. 5, 2024

(54) Wireless Power Transfer Network with Smart Features

(71) Applicant: Huawei Technologies Co., Ltd., Shenzhen (CN)

(72) Inventor: Muhammad Umer Farooq, Kista (SE)

(21) Appl. No.: 18/647,492

(22) Filed: Apr. 26, 2024

Related U.S. Application Data
(63) Continuation of application No. PCT/EP2021/080088, filed on Oct. 29, 2021.

(51) Int. Cl. H02J 50/80; H02J 7/00; H02J 50/20; H02J 50/40

(52) U.S. Cl. CPC H02J 50/80; H02J 7/00034; H02J 7/0048; H02J 50/20; H02J 50/40

(57) ABSTRACT

A wireless power transfer controller in a wireless power transfer network is configured to receive a wireless power transfer request message for a wireless power receiver and execute a wireless power transfer load-balancing algorithm among a plurality of wireless power transmitters. A wireless power transmitter is selected from the plurality of wireless power transmitters to serve the wireless power receiver based upon a result of the execution of the wireless power transfer load-balancing algorithm.

### CROSS-REFERENCE TO RELATED APPLICATIONS

This application is a continuation of International Patent Application No. PCT/EP2021/080088 filed on Oct. 29, 2021, the disclosure of which is hereby incorporated by reference in its entirety.

### TECHNICAL FIELD

The aspects of the disclosed embodiments relate generally to far-field wireless power transmission (WPT) and, more particularly to wireless power delivery in a wireless power transfer network.

### BACKGROUND

Far-field WPT can eliminate the need to place a device on a charging pad for wireless charging. It is possible to place a number of transmitters in a certain geographical area, and the transmitters can deliver wireless power to a number of receivers. In a wireless power transfer network (WPTN) there can be multiple wireless power transmitters and wireless power receivers. The presence of multiple transmitters and receivers can create an imbalance in the number of receivers being serviced by different transmitters in a network. There is a need to manage transmitters and receivers to deliver wireless power service in an effective and efficient manner.

Wireless power receiver device, and in particular, battery operated wireless powered devices, may have diverse sets of wireless power delivery requirements. Extensive differentiation can be required in order to effectively provide wireless power transfer services for these devices. Additionally, since wireless power transfer has different characteristics as compared to data communication, differentiation frameworks for data communication cannot be applied to wireless power transfer networks.

Communication technologies, such as, ZIGBEE®, Thread, WIFI®, Long-Term Evolution (LTE), LoRa® etc. are used to form and manage a data communication network. These existing communication technologies are designed and optimized for data communication. A wireless power transfer network not only needs to facilitate data communication, it also requires effective delivery of wireless power to multitude of receivers with different capabilities and power delivery requirements. Existing communication technologies do not address the listed challenges associated with far-field wireless power delivery in a wireless power transfer network.

Thus, there is a need for improved apparatus and methods that can efficiently determine which wireless power transmitter among available transmitters to deliver wireless power to a wireless power receiver since different wireless power receiver devices have different power requirements, and a wireless power transfer network should utilize the available resources in a way that results in effective and efficient wireless power delivery service. Accordingly, it would be desirable to provide methods and apparatuses that address at least some of the problems described above.

### SUMMARY

The aspects of the disclosed embodiments are directed to wireless power transfer load balancing in a wireless power transfer network and reshuffling wireless power transmitter to wireless power receiver associations in response to new events in an attempt to better provide wireless power transfer service to wireless power receiver devices. This and other objectives are solved by the subject matter of the independent claims. Further advantageous embodiments can be found in the dependent claims.

According to a first aspect, the above and further objectives and advantages are obtained by a wireless power transfer controller in a wireless power transfer network. In one embodiment, the wireless power transfer controller is configured to receive a wireless power transfer request message for a wireless power receiver; execute a wireless power transfer load-balancing algorithm among a plurality of wireless power transmitters; and select a wireless power transmitter from the plurality of wireless power transmitters to serve the wireless power receiver based upon a result of the execution of the wireless power transfer load-balancing algorithm. The aspects of the disclosed embodiments reduce wireless power transfer load imbalance among wireless power transmitters in a wireless power transfer network.

In a possible implementation form the wireless power transfer controller is configured to execute the wireless power transfer load-balancing algorithm by instructing the plurality of wireless power transmitters to transmit a wireless power signal to the wireless power receiver; receive a report from the wireless power receiver that indicates a received power from the plurality of wireless power transmitters; and select the wireless power transmitter from the plurality of wireless power transmitters based on a received power of the wireless power transmitter and an existing wireless power transfer load on the wireless power transmitter. The information on how much power can be transmitted by a candidate transmitter and the existing wireless power transfer load on each candidate transmitter can be used for wireless power transfer load balancing among candidate transmitters.

In a possible implementation form the wireless power transfer controller is configured to execute the wireless power transfer load-balancing algorithm by mapping a measured received signal strength indicator (RSSI) at a wireless power receiver to an approximate received wireless power for each of the plurality of wireless power transmitters; and select the wireless power transmitter from the plurality of wireless power transmitters based on the mapping of a measured RSSI to an approximate received power of the wireless power transmitter and an existing load on the candidate wireless power transmitter(s). The aspects of the disclosed embodiments enable determining an average wireless received power corresponding to a given RSSI value for wireless power transfer load balancing.

In a possible implementation form the wireless power transfer controller is further configured to execute the wireless power transfer load balancing algorithm for selecting the wireless power transmitter based on one or more of a type of the wireless power receiver, a priority of the wireless power receiver, a remaining battery level of the wireless power receiver, a battery type of the wireless power receiver, a capacity of a battery of the wireless power receiver, and a per unit energy requirement of the wireless power receiver. Specific details of each wireless power receiver can be used to determine a wireless power transmitter to serve the wireless power receiver.

In a possible implementation form the wireless power transfer controller is further configured to identify a wireless power receiver served by the wireless power transmitter for which a power delivery requirement is not met after the wireless power transmitter is selected to serve the wireless power receiver; identify at least one other wireless power transmitter within a range of the wireless power receiver; execute the load-balancing algorithm among the at least one other power transmitter to identify another wireless power transmitter to serve the wireless power receiver; and select the another wireless power transmitter to serve the wireless power receiver if the wireless power transfer controller determines that power delivery requirements of the wireless power receiver are not violated by assigning the wireless power transmitter to serve the wireless power receiver. The aspects of the disclosed embodiments enable reshuffling wireless power transmitter to wireless power receiver associations in response to device events and power requirements.

In a possible implementation form, selecting the wireless power transmitter to serve the wireless power receiver further comprises the wireless power transfer controller determining that assigning the wireless power transmitter to serve the wireless power receiver does not violate a maximum power delivery threshold of the wireless power transmitter. The aspects of the disclosed embodiments enable reshuffling wireless power transmitter to wireless power receiver associations in response to device events and power requirements.

In a possible implementation form the wireless power transfer controller is further configured to receive the wireless power transfer request message from the wireless power receiver over a communication link between the wireless power transfer controller and the wireless power receiver; communicate the selection of the wireless power transmitter together with identifying information of the wireless power transmitter to the wireless power receiver via the communication link. The wireless power transfer controller of the disclosed embodiments supports different data communication topologies between the wireless network transfer controller, wireless power transmitter and wireless power receiver.

In a possible implementation form the wireless power transfer controller is further configured to receive the wireless power transfer request message from one or more of the plurality of wireless power transmitters over a communication link between the wireless power transfer controller and the one or more of the plurality of wireless power transmitters; and communicate the selection of the wireless power transmitter together with identifying information of the wireless power receiver to the wireless power transmitter via the communication link. The wireless power transmitters relay wireless power request message that they receive from a wireless power receiver. The selected wireless power transmitter also relays information of interest to a wireless power receiver. The wireless power transfer controller of the disclosed embodiments supports different data communication topologies between the wireless network transfer controller, wireless power transmitter, and wireless power receiver.

According to a second aspect, the above and further objectives and advantages are obtained by a method. In one embodiment, the method for wireless power delivery in a wireless power transfer network includes receiving a wireless power transfer request message for a wireless power receiver; executing a wireless power transfer load-balancing algorithm among a plurality of wireless power transmitters; and selecting a wireless power transmitter from the plurality of wireless power transmitters to serve the wireless power receiver based upon a result of the execution of the wireless power transfer load-balancing algorithm. The aspects of the disclosed embodiments reduce wireless power load imbalance among wireless power transmitters in a wireless power transfer network.

In a possible implementation form the method further includes executing the wireless power transfer load-balancing algorithm by instructing the plurality of wireless power transmitters to transmit a wireless power signal to the wireless power receiver; receiving a report from the wireless power receiver that indicates a received power from the plurality of wireless power transmitters; and selecting the wireless power transmitter from the plurality of wireless power transmitters based on a received power of the wireless power transmitter and an existing wireless power transfer load on the wireless power transmitter. The information on how much power can be transmitted by a candidate transmitter can be used for wireless power transfer load balancing among candidate transmitters.

In a possible implementation form the method further includes executing the wireless power transfer load-balancing algorithm by mapping a measured RSSI at a wireless power receiver to an approximate received wireless power for each of the plurality of wireless power transmitters; and selecting the wireless power transmitter from the plurality of wireless power transmitters based on the mapping of a measured RSSI to an approximate wireless received power of the wireless power transmitter and an existing load on the wireless power transmitter. The aspects of the disclosed embodiments enable determining an average wireless received power corresponding to a given RSSI value for load balancing.

In a possible implementation form the method further includes executing the wireless power transfer load balancing algorithm for selecting the wireless power transmitter based on one or more of a type of the wireless power receiver, a priority of the wireless power receiver, a remaining battery level of the wireless power receiver, a battery type of the wireless power receiver, a capacity of a battery of the wireless power receiver, and a per unit energy requirement of the wireless power receiver. Specific details of each wireless power receiver can be used to determine a wireless power transmitter to serve the wireless power receiver keeping in-view the wireless power transfer load-balancing feature of the disclosed embodiments.

In a possible implementation form the method further includes identifying a wireless power receiver served by the wireless power transmitter for which a power delivery requirement is not met after the wireless power transmitter is selected to serve the wireless power receiver; identifying at least one other wireless power transmitter within a range of the wireless power receiver; executing the wireless power transfer load-balancing algorithm among the at least one other power transmitter to identify another wireless power transmitter to serve the wireless power receiver; and selecting the another wireless power transmitter to serve the wireless power receiver if the wireless power transfer controller determines that power delivery requirements of the wireless power receiver are not violated by assigning the wireless power transmitter to serve the wireless power receiver. The aspects of the disclosed embodiments enable reshuffling wireless power transmitter to wireless power receiver associations in response to device events and power requirements.

In a possible implementation form the method further includes selecting the wireless power transmitter to serve the wireless power receiver by determining that assigning the wireless power transmitter to serve the wireless power receiver does not violate a maximum power delivery threshold of the wireless power transmitter. The aspects of the disclosed embodiments enable reshuffling wireless power transmitter to wireless power receiver associations in response to device events and power requirements.

In a possible implementation form the method further includes receiving the wireless power transfer request message from the wireless power receiver over a communication link between the wireless power transfer controller and the wireless power receiver; and communicating the selection of the wireless power transmitter together with identifying information of the wireless power transmitter to the wireless power receiver via the communication link. The method of the disclosed embodiments supports different data communication topologies between the wireless network transfer controller, wireless power transmitter and wireless power receiver.

In a possible implementation form the method further includes receiving the wireless power transfer request message from one or more of the wireless power transmitters over a communication link between the wireless power transfer controller and the one or more wireless power transmitters; and communicating the selection of the wireless power transmitter together with identifying information of the wireless power receiver to the wireless power transmitter via the communication link. In this example, the wireless power transmitters relay requests they receive from wireless power receivers to the wireless power transfer controller and also relay relevant information to concerned wireless power receivers. The aspects of the disclosed embodiments support different data communication topologies between the wireless power transfer controller, the wireless power transmitter and the wireless power receiver.

According to a third aspect, the above and further objectives and advantages are obtained by a non-transitory computer readable medium having stored thereon program instructions. The program instructions, when executed by a processor, are configured to cause the processor to perform the method according to any one or more of the possible implementation forms described herein.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosure, for which reference should be made to the appended claims. Additional aspects and advantages of the disclosure will be set forth in the description that follows, and in part will be obvious from the description, or may be learned by practice of the disclosure. Moreover, the aspects and advantages of the disclosure may be realized and obtained by means of the instrumentalities and combinations particularly pointed out in the appended claims.

### BRIEF DESCRIPTION OF DRAWINGS

In the following detailed portion of the present disclosure, the disclosure will be explained in more detail with reference to the example embodiments shown in the drawings, in which:

FIG. 1 illustrates a block diagram of an exemplary wireless power transfer network incorporating aspects of the disclosed embodiments.

FIG. 2 illustrates an exemplary process flow in a wireless power transfer network incorporating aspects of the disclosed embodiments.

FIG. 3 is a block diagram illustrating an exemplary communication topology in a wireless power transfer network incorporating aspects of the disclosed embodiments.

FIG. 4 is a block diagram illustrating an exemplary communication topology in a wireless power transfer network incorporating aspects of the disclosed embodiments.

FIG. 5 is a block diagram of an exemplary controller for a wireless power transfer network incorporating aspects of the disclosed embodiments.

FIGS. 6-9 illustrate exemplary message exchange sequences for a wireless power transfer network incorporating aspects of the disclosed embodiments.

FIG. 10 illustrates a block diagram of an exemplary wireless power transfer network incorporating aspects of the disclosed embodiments.

FIGS. 11-12 illustrate exemplary message exchange sequences for a wireless power transfer network incorporating aspects of the disclosed embodiments.

FIG. 13 illustrates a block diagram of an exemplary wireless power transfer network incorporating aspects of the disclosed embodiments.

### DESCRIPTION OF EMBODIMENTS

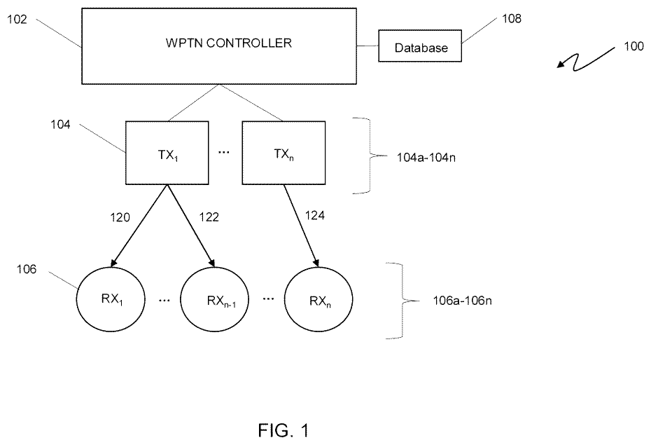

Referring to FIG. 1, a schematic block diagram of an exemplary wireless power transfer network (WPTN) or system 100 incorporating aspects of the disclosed embodiments is illustrated. The wireless power transfer network 100 is configured to provide wireless power transfer services. The wireless power transfer services can include, but are not limited to, far-field wireless charging. The aspects of the disclosed embodiments are directed to reducing wireless power transfer load imbalance among wireless power transmitters in a wireless power transfer network and enabling the shuffling or changing of wireless power transmitter to wireless power receiver associations in response to new events. New events can include, but are not limited to, a power request of a wireless power receiver or a priority of a wireless power receiver.

As shown in FIG. 1, the wireless power transfer network 100 generally comprises a wireless power transfer controller 102, one or more wireless power transmitters 104 and one or more wireless power receivers 106. The number of wireless power transmitters 104 and wireless power receivers 106 shown in FIG. 1 is merely for illustration purposes and does not limit the scope of the claimed subject matter. In alternate embodiments, the wireless power transfer network 100 can include any suitable number of wireless power transmitters 104 and wireless power receivers 106.

In one embodiment, the wireless power transfer controller 102 is configured to receive a wireless power transfer request message for or from a wireless power receiver 106. As will be further described herein, the wireless power transfer controller 102 is configured to receive the request from the wireless power receiver 106 or from one or more of the wireless power transmitters 104. The aspects of the disclosed embodiments provide and support different data and signaling communication topologies to enable communications and the relay of information to and between the wireless power transfer controller 102 and the wireless power receivers 106.

In one embodiment, communications between the wireless power transfer controller 102 and one or more of the wireless power receivers 106 takes place through one or more of the wireless power transmitters 104. In another embodiment, the one or more wireless power receivers 106 are configured to communicate directly with the wireless power transfer controller 102.

The wireless power transfer controller 102 is configured to execute a wireless power transfer load-balancing algorithm among a plurality of the wireless power transmitters, referred to as wireless power transmitters 104a-104n. In one embodiment, the execution of the wireless power transfer load balancing algorithm includes selecting a wireless power transmitter 104 from the plurality of wireless power transmitters 104a-104n to serve the wireless power receiver 106 based upon a result of the execution of the wireless power transfer load balancing algorithm.

The wireless power transfer controller 102 of the disclosed embodiments is generally configured with a number of smart features. These include the implementation of algorithms for wireless power transfer load balancing among available wireless power transmitters 104 in the wireless power transfer network 100. The wireless power transfer controller 102 is also configured to deliver priority services to prioritized wireless power receivers 106. The wireless power transfer controller 102 is also configured to change the wireless power transmitter 104 to wireless power receiver 106 associations in response to a new wireless power transfer request for a wireless power receiver device 106. Examples of such wireless power receiver devices 106 can include, but are not limited to smart phones or Internet of Things (IoT) devices.

In one embodiment, the wireless power transfer controller 102 will include or be communicatively connected to a database or other suitable memory or storage device 108. The database 108 is generally configured to store or maintain information or data related to the wireless power transmitter(s) 104 and the wireless power receiver(s) 106. In one embodiment, the database 108 can also include data and information, generally referred to as information herein, on the wireless power transfer controller 102. The wireless power transfer controller 102 is configured to access this information for use in conjunction with the aspects of the embodiments disclosed herein.

In one embodiment, this information related to the wireless power transmitter(s) 104 can include, but is not limited to, a capability of each wireless power transmitter 104, a number of antennas, a number of supported beam directions, per unit power delivery capabilities and data communication interfaces. The database 108 is also configured to store information on wireless power transmitter to wireless power receiver associations and wireless power receiver credential. The stored information can also include information about registered users/customers and network controlling authority information.

In one embodiment, the database 108 can also include or maintain a list of wireless power receivers 106 that each wireless power transmitter 104 is serving or is configured to serve as well as information related to the wireless power receiver device(s) 106. Examples of the information related to the wireless power receiver device(s) 106 that can be maintained in the database 108 can include, but is not limited to, a type of the wireless power receiver device 104, a type of battery, a current battery status, remaining charging time, priority, receiver identifier and per unit power requirements.

In one embodiment, the wireless power transfer controller 102 can also be configured to maintain a current status of individual ones of the wireless power transmitter(s) 104 and wireless power receiver(s) 106 in the wireless power transfer network 100. In one embodiment, this status information and data can also be maintained in the database 108 and is configured to be accessible by the wireless power transfer controller 102. Other information and data, such as subscription data, usage data, and billing information corresponding to each wireless power receiver device 106 can be maintained the wireless power transfer controller 102.

The wireless power transmitter(s) 104 are generally devices or apparatus that are configured to deliver electrical power wirelessly to the one or more wireless power receivers 106 in the wireless power transfer network 100. The wireless power transmitter(s) 104 can be configured to execute software that enables the wireless power transmitter(s) 104 to communicate with one or more of the wireless power receiver(s) 106 and the wireless power transfer controller 102, as is generally described herein.

In one embodiment, the wireless power transmitter(s) 104 are configured to assist with the on-boarding of a wireless power receiver 106 onto the wireless power transfer network 102. The wireless power transmitter(s) 104 of the disclosed embodiments are also configured to maintain, or otherwise have access to, information about the wireless power receiver(s) 106 that they are serving or otherwise connected to. The wireless power transmitter(s) 104 is also configured to maintain or have access to information about aspects of the wireless power transfer network 100, including for example, but not limited to, aspect of the wireless power transfer controller 102.

The wireless power receiver(s) 106 are generally devices or apparatus that are configured to receive electrical power wirelessly. The wireless power receiver(s) 106 are configured to execute software that enables the wireless power receiver(s) 106 to communicate with one or more of the wireless power transmitter(s) 104 and the wireless power transfer controller 102. The wireless power receiver(s) 106 are also configured to maintain, or have access to, information about the wireless power transmitter(s) 104 to which a wireless power receiver 106 is connected for wireless power delivery. In one embodiment, the wireless power receiver(s) 106 is also configured to have access to or maintain information about aspects of the wireless power transfer network 100, including for example, but not limited to aspects of the wireless power transfer controller 102.

Referring again to FIG. 1, the wireless power transfer controller 102 is configured to balance wireless power transfer load between available wireless power transmitters 104a-104n, deliver priority services to priority wireless power receivers 106a-106n and change transmitter to receiver associations in response to a new wireless power transfer request for or from a wireless power receiver. In accordance with the aspects of the disclosed embodiments, the wireless power transfer load balancing among wireless power transmitters 104a-104n implemented by the wireless power transfer controller 102 can be power signal based wireless power transfer load balancing or RSSI based wireless power transfer load balancing.

In power-signal-based wireless power transfer load balancing, whenever a wireless power receiver device 106 needs wireless power the wireless power transfer controller 102 instructs transmitters 104a-104n in range of the wireless power receiver 106 to transmit a power signal to the wireless power receiver 106. Generally, the power signal will be transmitted by the wireless power transmitters 104a-104n for a defined span of time. In one embodiment, the wireless power receiver 106 reports the received power back to the wireless power transfer controller 102.

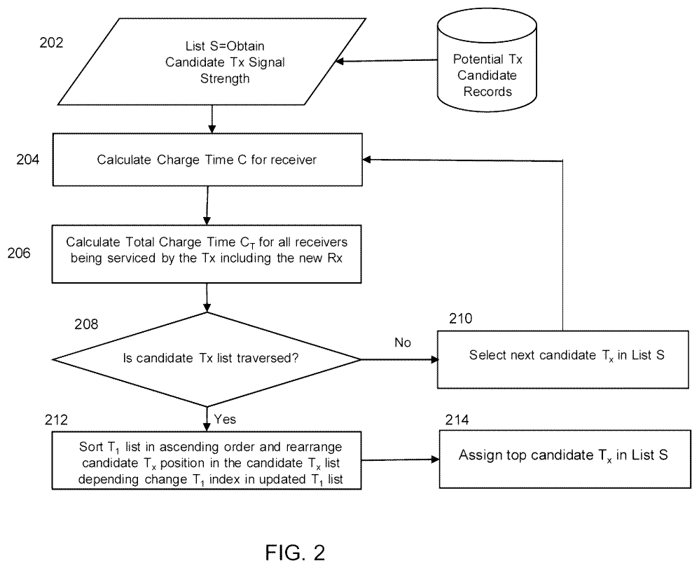

Once the process is complete for each wireless power transmitter 104a-104n in the range of the wireless power receiver 106, the wireless power transfer controller 102 executes a wireless power transfer load balancing algorithm to select one of the available wireless power transmitters 104a-104n to service the wireless power receiver 106. FIG. 2 illustrates one example of a wireless power transfer load balancing algorithm incorporating aspects of the disclosed embodiment.

Referring also to FIG. 2, in one embodiment, the wireless power transfer controller 102 is configured to retrieve 202 information on the candidate wireless power transmitters 104a-104n, referred to in this example as Tx. In one embodiment, the information on available candidate wireless power transmitters Tx is retrieved from the database 108. The candidate wireless power transmitters Tx can be those wireless power transmitters 104a-104n that are within a predetermined range of the wireless power receiver 106 that is requesting wireless power. In one embodiment, the information on the candidate wireless power transmitters 104a-104n is stored or maintained in a list, or other such other suitable record, generally referred to herein as candidate List S.

In one embodiment, the wireless power transfer controller 102 is configured to further apply filtering to shortlist the candidate transmitters Tx in the candidate transmitters list S. The filtering can include, for example, but is not limited to, defining a threshold RSSI value and only considering those wireless power transmitters 104a-104n as the candidate wireless power transmitters Tx for the List S whose measured RSSI value at the requesting wireless power receiver 106 is above the defined RSSI threshold value. Alternatively, in one embodiment, the wireless power transfer controller 102 can consider only those candidate wireless power transmitters Tx from whom a received power is above a predetermined threshold.

In one embodiment, a time C required by each wireless power transmitter Tx in the candidate wireless power transmitters list S to charge the requesting wireless power receiver device 106 is calculated 202. Any suitable method to determine the time C required for a candidate wireless power transmitter Tx to charge the requesting wireless power receiver device 106 can be used. In one embodiment, the charging time C is calculated 206 by considering one or more of: the amount of power that the wireless power transmitter 104 can deliver to the wireless power receiver 106 per unit time, type of wireless power receiver device 104, type of receiver device battery, remaining battery level of the receiver device and battery capacity of the receiver device.

Once the charging time C to charge the requesting wireless power receiver 106 is calculated 204, the total charging time CT for all wireless power devices 106a-106n that are attached to the candidate wireless power transmitter Tx is calculated 206. The total charging time CT takes into account the remaining charging time of the wireless power receiver devices 106a-106n to whom the candidate wireless power transmitter Tx is already providing wireless power, and the calculated charging time C for the requesting wireless power receiver device. The calculation 206 of the total charging time CT can be performed by the wireless power transfer controller 102 or by the wireless power transmitter Tx.

In one embodiment, the List S of candidate transmitters Tx is then rearranged 212 in ascending order of the total charging time. Alternatively, another list can be created that ranks the candidate transmitters Tx in ascending order based on the total charging time CT. This process can be carried out 208, 210 for each candidate transmitter Tx in the List S.

In one embodiment, the wireless power transfer controller 102 is configured to assign 214 the candidate wireless power transmitter Tx from the List S that has the lowest total charging time CT to serve the requesting wireless power receiver 106. In the example where the candidate wireless power transmitters Tx are ranked by charging time C in ascending order, the selected wireless power transmitter 104 will be the first ranked transmitter in the List S. In alternate embodiments, the List S of candidate wireless power transmitters Tx can be arranged or ranked in any suitable manner.

Additionally, other operational aspects of the wireless power receiver device 106 can also be taken into account when assigning a wireless power transmitter 104 to serve a wireless power receiver 106 in accordance with the aspects of the disclosed embodiments. In one embodiment, these operational aspects can include, but are not limited to, the power requirements of the wireless power receiver 106, battery level, type of battery, battery capacity and priority, for example.

Operational aspects of the identified wireless power transmitters 104a-104n can also be take into consideration. In one embodiment, these operational aspects, which can be maintained in the database 108, can include, but are not limited to transmitter capabilities, the number and types of antenna as well as beam directions.

A wireless power transfer network not only needs to facilitate data communication, also requires effective delivery of wireless electrical power to a multitude of wireless power receivers with different capabilities. Wireless power transfer requirements differ from data communication requirements. For example, to deliver wireless power, a wireless power transmitter 104 needs to focus a radio frequency beam to the wireless power receiver 106 for a longer period of time than the time required to transmit a data frame from a sender to a receiver.

In a pure data communication network an access point typically handles a relatively large number of devices. However, for effective wireless power delivery, a wireless power transmitter 104 can only handle a few receivers.

Different battery operated devices may have diverse wireless power delivery requirements. As wireless power transfer has different characteristics compared to data communication, service differentiation frameworks for data communication cannot be equally applied to wireless power transfer networks.

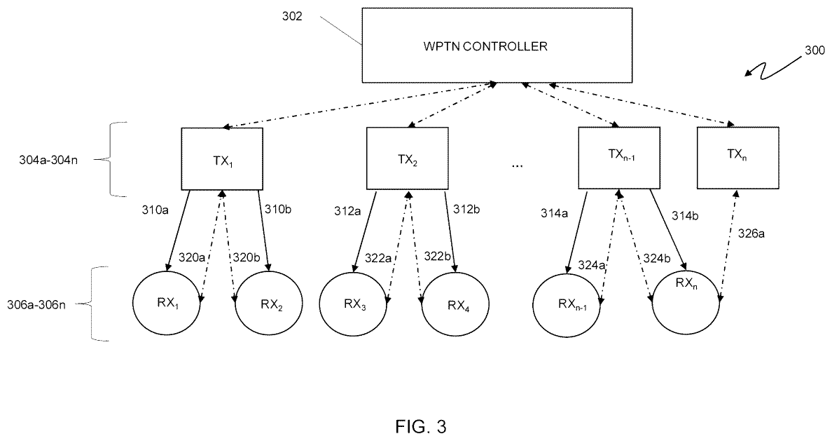

FIG. 3 illustrates one embodiment of a wireless power transfer network 300 incorporating aspects of the disclosed embodiments. In this example, the data communication between wireless power receivers 306a-306n and the wireless power transfer controller 302 takes place through one or more of the wireless power transmitters 304a-304n. In this example, data communication links are illustrated in dashed lines while power delivery is illustrated in solid lines. Thus, as shown in FIG. 3, data communication between the wireless power transmitters 304a-304n takes place via respective ones of the communication links 310a, 310b, 312a, 312b, 314a and 314b. Power delivery is illustrated by links 320a, 320b, 322a, 322b, 324a and 324b.

In the wireless power transfer network 300 illustrated in FIG. 3, the wireless power transfer controller 302 can reside inside the same building as the wireless power transmitter 304. Alternatively, the wireless power transfer controller 302 can be located in a remote location where it can be communicably coupled to the wireless power transmitter 304a-304n, such as the cloud. Generally, the wireless power transfer controller 302 can be disposed at any suitable location as long as wireless power transmitters 304a-304n have a communication link with the wireless power transfer controller 302.

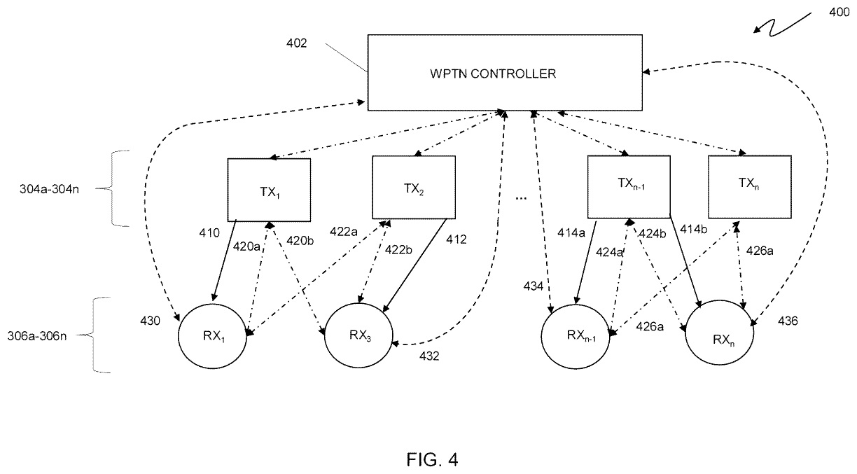

FIG. 4 illustrates another exemplary wireless power transfer network 400 incorporating aspects of the disclosed embodiments. In this example, the data communication topology is such that the wireless power receivers 406a-406n are configured to communicate directly with the wireless power transfer controller 402. In this example, data communication links are illustrated in dashed lines while power transfer links are illustrated in solid lines. Thus, as shown in FIG. 4, the wireless power receivers 406a-406n are configured to communicate with the wireless power transfer controller 402 over communication links 430, 432, 434 and 436, respectively. The wireless power transmitters 404a-404n are configured to communicate with the wireless power receivers 406a-406n via one or more of the exemplary communication links 420a, 420b, 422a, 422b, 424a and 424b. In this example, power is transferred over the power transfer links 410, 412, 414a and 414b. It will be understood that communication links and power transfer links can be established between any one or more of the wireless power transmitters 404a-404n and the wireless power receivers 406a-406n.

In the embodiment of FIG. 4, the wireless power transfer controller 402 is suitably located where each wireless power receiver 406a-406n can communicate with it directly. In a situation where wireless power receivers 406a-406n can communicate over the Internet, the wireless power transfer controller 402 can also be located remotely, such as in the cloud.

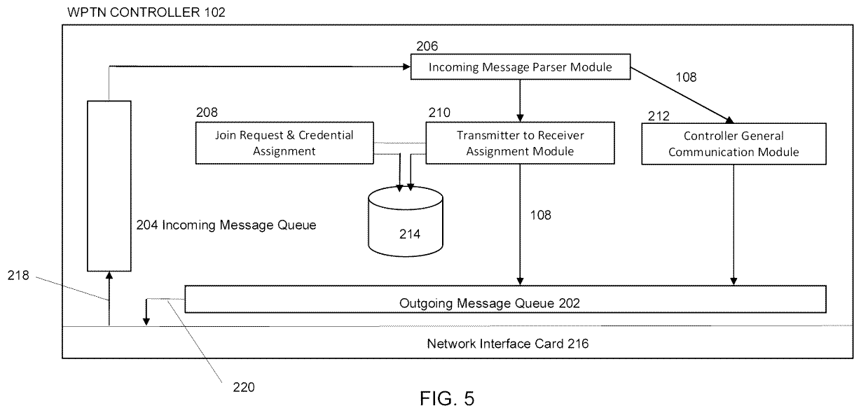

FIG. 5 is a block diagram of a wireless power transfer controller 502 incorporating aspects of the disclosed embodiments. In this example, the wireless power transfer controller 502 includes an outgoing message queue 502, incoming message queue 504, incoming message parser module 506, join request and credential assignment module 508, transmitter to receiver assignment module 510, general communication module 512, and a database 514. In one embodiment, the database 108 of FIG. 1 and the database 514 of FIG. 5 are the same, or part of the same database.

The incoming messaging queue 504 is generally configured to buffer messages received from a network interface card (NIC) 516 that is communicably coupled or connected to the wireless power transfer controller 502. The message 518 at the head of the incoming message queue 504 is delivered to the incoming message parser module 506. Based on the type of message, the incoming message parser module 506 forwards the message to one of the transmitter to receiver assignment module 510 or transfer controller general communication module 512.

The Join Request & Credential Assignment module 508 is configured to handle the network join request of the wireless power receiver 506. The Join Request & Credential Assignment module 508 is configured to assign an application identifier to the requesting wireless power receiver 506 and an application level security key. The Join Request & Credential Assignment module 508 also inserts data corresponding to the requesting wireless power receiver 506 in the transfer controller database 514.

The Transmitter to Receiver Assignment module 510 is configured to implement the wireless power transfer load balancing algorithms. In one embodiment, the Transmitter to Receiver Assignment module 510 is configured to select a wireless power transmitter 504 for a wireless power receiver 506 after implementing the wireless power transfer load balancing algorithm incorporating aspects of the disclosed embodiments. The Transmitter to Receiver Assignment module 510 updates the database 514 with the required information about the wireless power receiver 506 and the wireless power transmitter 504. The Transmitter to Receiver Assignment module 510 can also be invoked when the wireless power transfer controller 502 infers that the amount of power delivered to a wireless power receiver 506 is lower than what is required, an initiates a reshuffling of wireless power transmitter to wireless power receiver assignment.

The Transfer Controller General Communication module 512 is configured to control communication between the wireless power transfer controller 502 and the wireless power transmitters 504a-504n. The communication between the wireless power transfer controller 502 and the wireless power receiver(s) 506 is handled by the transfer controller general communication module 512.

The Outgoing Message Queue 502 is configured to buffer messages that need to be transmitted by the wireless power transfer controller 502. Outgoing messages 520 are handed over to the network interface card 516 for transmission.

Referring again to the example of FIG. 3, the wireless power receivers TX1, TX2 and TX(n−1) are respectively associated with two receivers. Namely TX1 is associated with RX1 and RX2; TX2 with RX3 and RX4, and TX3 with RX (n−1) and RXn. However, as is shown in the example of FIG. 3, there is no wireless power receiver associated with wireless power transmitter TXn.

In the example of FIG. 3, wireless power receiver RXn, associated with wireless power transmitter TX(n−1), is also configured to be associated with wireless power transmitter TXn. Since there is no wireless power receiver is associated with wireless power transmitter TXn, there can be wireless power transfer load imbalance in the wireless power transfer network 300.

One assumption in this example is that receiver RXn is serviced by TX(n−1) because at the receiver RXn the RSSI from TX(n−1) is high compared to TXn. A lower RSSI from TXn means that RXn will require more time to charge if it is serviced by TXn. However, TX(n−1) is already servicing RX (n−1), and thus has to time multiplex wireless power delivery to both receivers RXn and RX (n−1)

For example, if RX (n−1) and RXn both require 30 minutes to fully charge if they receive wireless power from TX(n−1), TX(n−1) will require 1 hour to fully charge both wireless power receiver devices RX (n−1) and RXn. However, if it is assumed that due to the reduced RSSI, RXn is serviced by TXn, it will fully charge RXn in 40 minutes. In this case, RX (n−1) will be fully charged in 30 minutes, and RXn will be fully charge in 40 minutes. The wireless power transfer controller 402 is configured to implement wireless power transfer load balancing in the wireless power transfer network 400 in accordance with the aspects of the disclosed embodiments to achieve balanced wireless power transfer between TX(n−1) and TXn.

Referring again to FIG. 1, in one embodiment, the wireless power transfer controller 102 is configured to store or access a lookup table that gives an approximate value of energy that can be harvested by a wireless power receiver device 106 corresponding to a given RSSI value. The RSSI value can correspond to any communication technology used by a wireless power transmitter and wireless power receiver for data communication.

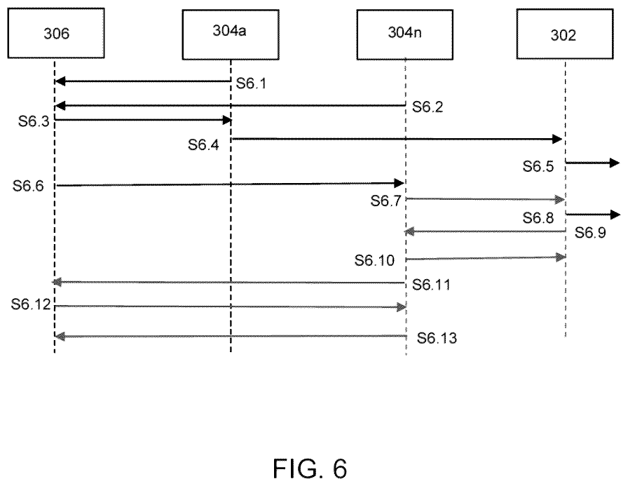

Referring also to FIG. 6, in one embodiment, a wireless power receiver 306 receives “Hello” messages S6.1, S6.2, that are periodically transmitted by one or more wireless power transmitters 304a-304n. The wireless power receiver 306 is configured to receive the “Hello” messages S6.1, S6.2 from the one or more wireless power transmitters 304a-304n that are within its range.

When a wireless power receiver 306 wishes to join the wireless power transfer network 302 to receive wireless power, it broadcasts S6.3 the “join” message. The “join” message can also include the following information about the wireless power receiver device 306 including, for example one or more of a device type, device priority, remaining battery level, device's battery type, device's battery capacity and device per unit energy requirement. The “join” message can also include the information about each wireless power transmitter 304a-304n from whom it could hear the “Hello” message, and the corresponding RSSI value.

Any one of the wireless power transmitters 304a-304n who hears the “join” message will relay S6.4 the message to the wireless power transfer network controller 302. There can be multiple wireless power transmitters 304a-304n who relayed the same “join” message to the wireless power transfer controller 102. Therefore, when the wireless power transfer controller 302 receives the first “join” message it waits during timeout S6.6 for some time assuming that within a small period of time the same message may arrive through a different one of the wireless power transmitters 304a-304n. For example, a “join” message can be relayed S6.7 from wireless power receiver 306 to wireless power transmitter 304n, and then relays S6.8 from wireless power transmitter 304n to the wireless power controller 302.

In one embodiment, the timeout S6.6 comprises buffering the join request and starting a timer. The controller 302 then waits for join requests to arrive from other wireless power transmitters 304a-304n.

After the timeout S6.6, the wireless power transfer controller 102 executes S6.9 the wireless power transfer load balancing algorithm of the disclosed embodiments and selects the wireless power transmitter 304n for the wireless power receiver 306 from the one or more wireless power transmitters 304a-304n who relayed the wireless power receiver's 306 join request. Once, the wireless power transfer controller 302 selects an appropriate wireless power transmitter 304n for the wireless power receiver 306, the wireless power transfer controller 102 instructs S6.10 the selected wireless power transmitter 304n in this example to handle or serve the wireless power receiver 306. In one embodiment, the selected wireless power transmitter 304n acknowledges S6.11 the instruction. Afterwards, the wireless power transmitter 304n shares S6.12 the relevant information (device ID, transmitter ID, security keys, etc.) with the wireless power receiver 304. In one embodiment, the wireless power receiver 306 acknowledges S6.13 the receipt of the information. The wireless power transmitter 304n is then configured to deliver S6.14 wireless electrical power to the wireless power receiver 306.

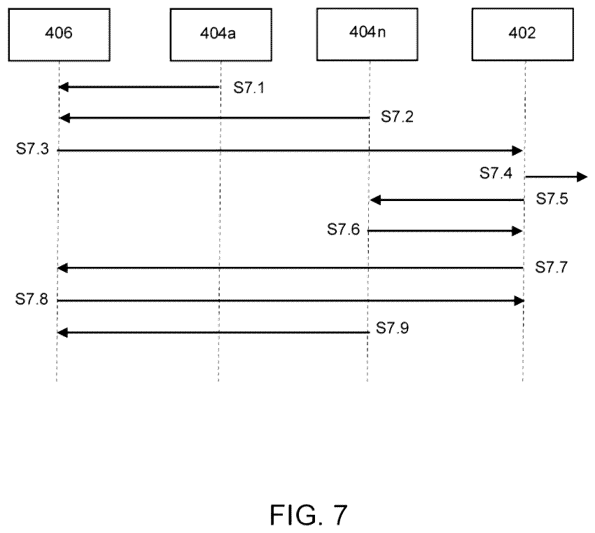

The communication process shown in FIG. 6 corresponds to the communication topology illustrated in FIG. 4. FIG. 7 illustrates the communication process for the communication topology illustrated in FIG. 4, where the wireless power receiver 406 is communicating directly with the wireless power transfer controller 402.

In the example of FIG. 7, the wireless power transmitters 404a-404n periodically generate S7.1, S7.2 “Hello” messages. In one embodiment, the wireless power receiver 406 sends S7.3 a “join” message to the wireless power transfer controller 402. The join message S7.3 can include additional information on the wireless power receiver 406. The wireless power controller 402 is configured to execute S7.4 the wireless power transfer load balancing algorithm of the disclosed embodiments and select the wireless power transmitter 404n for the wireless power receiver 406 from the one or more wireless power transmitters 404a-404n.

The instruction is sent S7.5 to the selected wireless power transmitter 404n. The selected transmitter 404n acknowledges S7.6 the instruction. The wireless power transfer controller 402 is configured to inform S7.7 the wireless power receiver 406, together with information on the wireless power transmitter 404n. The information is acknowledged S7.8 and the selected wireless power transmitter 404n can then deliver S7.9 wireless power to the wireless power receiver 406.

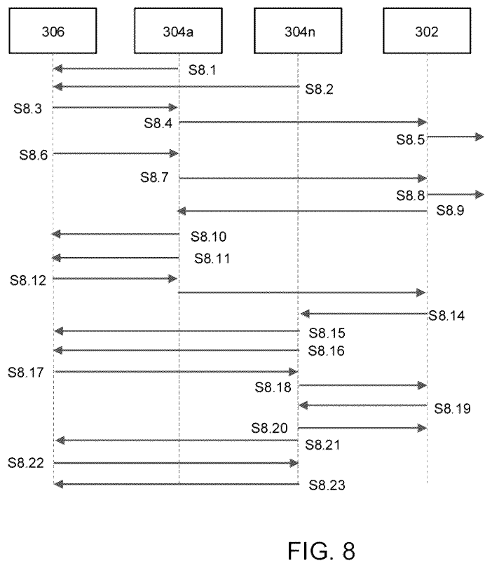

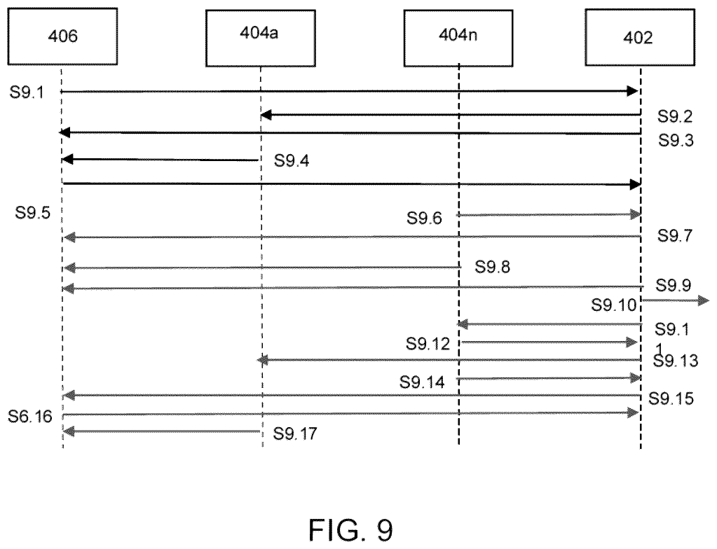

Referring also to FIGS. 8 and 9, in power-signal-based wireless power transfer load balancing according to the disclosed embodiments, whenever a wireless power receiver device 106 needs wireless power, the wireless power transfer controller 102 instructs wireless power transmitters 104a-104n in range of the wireless power receiver 106 to transmit a power signal for a defined short span of time to the wireless power receiver 106. The wireless power receiver 106 reports back the received power to the wireless power transfer controller 102.

For example, as shown in FIG. 8, “hello” messages are transmitted S8.1, S8.2 from wireless power transmitters 304a-304n to the wireless power receiver 306. The wireless power receiver 306 sends S8.3 a “join” message. A wireless power transmitter 304a-304n relays S8.4 the join message to the wireless power transfer controller 302. Other transmitters can also relay S8.5 and S8.7 the join message during the timeout S8.6.

At the end S8.8 of the timeout, the wireless power transfer controller 302 instructs S8.9 the wireless power transmitter 304a-304n to send S8.10 a power signal for a defined duration. The wireless power transmitter(s) 304a-304n send S8.11 the power signal. Information on the received power signal is sent S8.12 from the wireless power receiver 306 to the wireless power transmitter 304a-304n. The information is relayed S8.13 to the wireless power transfer controller 302. This process is repeated S8.14-S8.18 for each of the wireless power transmitters 304a-304n.

Once, the process is complete for each wireless power transmitter 304a-304n, the wireless power transfer controller 302 executes the wireless power transfer load balancing algorithm presented in FIG. 2 to select a wireless power transmitter 304n for the wireless power receiver 306. The wireless power transfer controller 302 instructs S8.20 the selected wireless power transmitter 304n to serve the wireless power receiver 306. In one embodiment, the wireless power receiver 306 is informed S8.21 about the selected wireless power transmitter 304n.

The instructions are acknowledged S8.22. The selected wireless power transmitter 304n is configured to deliver S8.23 the wireless power.

The sequence diagram for the process corresponding to the communication topology illustrated in FIG. 4 is shown in FIG. 9. As shown in the example of FIG. 9, the wireless power transfer controller 402 receives S9.1 status information from the wireless power receiver 406. The wireless power transfer controller 402 instructs S9.2, S9.3 the wireless power transmitters 404a-404n to transmit a power signal. The wireless power transmitters 404a-404n transmit S9.4 the power signal.

The wireless power control 402 receives S9.5 information on the power received by the wireless power receiver 406. In one embodiment, the wireless power controller 402 will instruct S9.6 each of the wireless power transmitters 404a-404n to transmit S9.6-S9.8 the power signal and then receive S9.9 information on the transmitted power signals.

The wireless power transfer controller 402 executes S9.10 the wireless power transfer load balancing algorithm of the disclosed embodiments. A new wireless power transmitter 404n for the wireless power receiver 406 is selected from the one or more wireless power transmitters 404a-404n.

The current association between the wireless power receiver 406 and the serving wireless power transmitter 406n is terminated S9.11. In one embodiment, the termination is acknowledged S9.12. The selected wireless power transmitter 404a is instructed S9.13 to serve the wireless power receiver 406.

Information about the selected wireless power transmitter 404a is sent to the wireless power receiver 406. This transmission can also be acknowledged S9.16. The selected wireless power transmitter 404a delivers S9.17 wireless power to the wireless power receiver 406.

In one embodiment, in case of an event, such as, a new wireless power receiver needs wireless power the wireless power network transfer controller 102 is configured to reshuffle the wireless power transmitter 104 to wireless power receiver 106 assignment. Example events that can trigger this functionality, include but are not limited to, an energy hungry wireless power receiver device requests wireless power transfer, or a new wireless power receiver requests wireless power transfer. However, the wireless power transmitters may not satisfy power requirements of the wireless power receiver in case they continue to service the existing wireless power receivers wireless power requests.

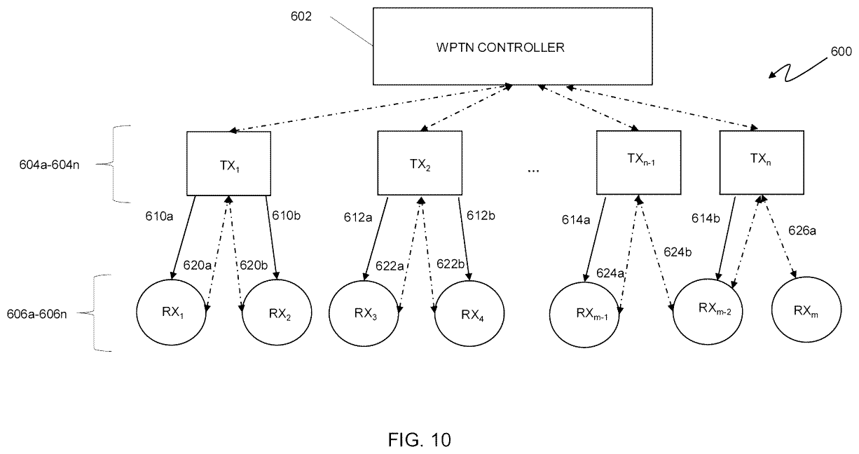

Referring to the exemplary wireless power transfer network 600 shown in FIG. 10, receiver Rxm requests wireless power transfer, and it is only within the range of transmitter Txn. Thus, Txn is the only wireless power transmitter that can deliver wireless power to Rxm.

Txn is already delivering wireless power to Rx(m−1). Assuming that if Txn services both Rxm and Rx(m−1), the power requirements of Rxm cannot be satisfied due to the limitation on the wireless power that can be transmitted by the wireless power transmitter. Hence, the wireless power transfer network controller 602 is configured to execute a transmitter to receiver reshuffling algorithm to determine a new assignment that could satisfy the power requirements of the wireless power receiver Rxm.

In this case, the process begins by considering that Rxm has to be serviced by Txn. Afterwards, it will find the wireless power receivers being serviced by Txn can also be serviced by other wireless power transmitters. For each receiver, the wireless power transfer network controller 602 will determine whether moving one of the wireless power receivers serviced by Txn to another wireless power transmitter violates a power delivery threshold of the candidate transmitter. In that case, the receiver can be allocated to the candidate transmitter. Afterwards, the controller reshuffles the transmitter to receiver assignment after making sure that the new assignment will not violate the maximum power delivery threshold of each transmitter.

In the example considered here, the controller detaches Rx(m−1) from Txn, and assigns it to Tx (n−1). The controller 602 instructs Txn to service the Rxm request. If reshuffling is not possible, Txn in this case will deliver wireless power to Rxm. However, it is possible that a low amount of power will be delivered per unit time.

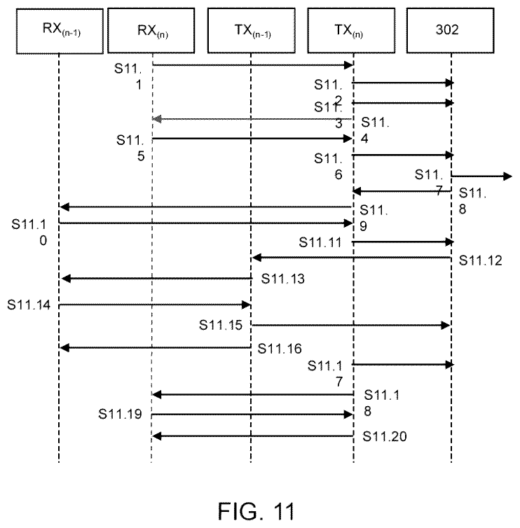

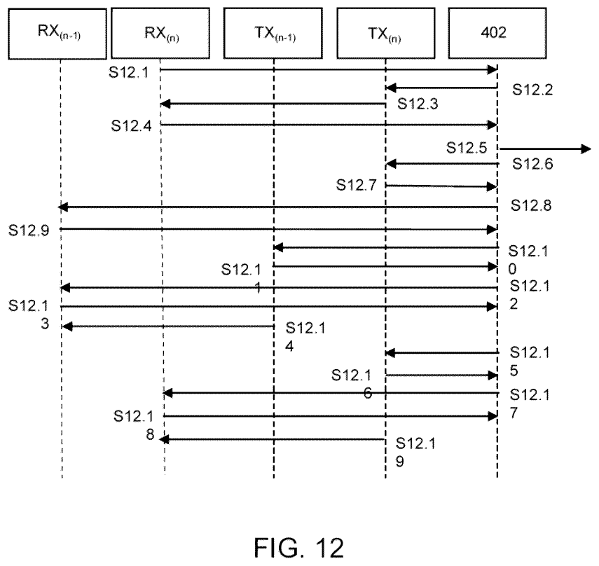

The sequences of messages exchanges for this example are illustrated in FIGS. 11 and 12. The communication sequence illustrated in FIG. 11 corresponds to the communication topology illustrated in FIG. 3, while the communication sequence in FIG. 12 corresponds to the communication topology of FIG. 4.

As is shown in FIG. 11, a “join” message is received S11.1 and relayed S11.2 to the wireless power transfer controller 302. A transmit power signal instruction S11.3 is send to the wireless power transmitters Tx(n)-Tx (n−1).

A power signal is sent S11.4 to the wireless power receiver Rx(n). Information on the transmitted power is sent S11.5 to the wireless power transmitter Tx (n) and relayed S11.6 to the wireless power transfer controller 302. An instruction S11.6 to terminate the current transmitter to receiver association is sent from the wireless power transfer controller 302 to the wireless power transmitter Tx (n). The instruction is relayed S11.8 to the wireless power receiver 306 and acknowledged S11.9, S11.10.

An instruction S11.11 for the wireless power transmitter Tx (n−1) to service the wireless power receiver 306 is sent and the new wireless power transmitter Tx (n−1) is assigned S11.12. This instruction and assignment is acknowledged S11.13 and S11.14.

A power signal is sent S11.15 to the wireless power receiver Rx(n+1). Information on the wireless power transmitter TX(n) is sent S11.16 to the wireless power receiver Rx(n). This is acknowledged S11.17 and the wireless power signal is sent S11.18.

In the example of FIG. 12, the join request S12.1 from receiver Rxm is received by the wireless power transfer controller 402. An instruction S2.2 to transmit a power signal is sent and the power signal is sent S12.3.

Information on the transmitted power is sent S12.4 to the wireless power transfer controller 402. The wireless power transfer controller 402 executes S12.5 the wireless power transfer load balancing algorithm of the disclosed embodiments and selects the wireless power transmitter Tx (n−1) for the wireless power receiver Rx(m−1) one or more wireless power transmitters Tx (n−1) to Tx (n).

An instruction S12.6 to terminate the current wireless power receiver to wireless power transmitter connection is sent S12.6 to S12.9. The wireless power transfer controller 402 informs S12.10 the wireless power transmitter Tx (n−1) to service the wireless power receiver Rx(m−1) and the wireless power receiver Rx(m−1) is informed S12.12 about the assignment. Power is delivered S12.14 to the wireless power receiver Rx(m−1). The process S12.15 to S12.19 is carried out for all wireless power transmitter to wireless power receiver relationships.

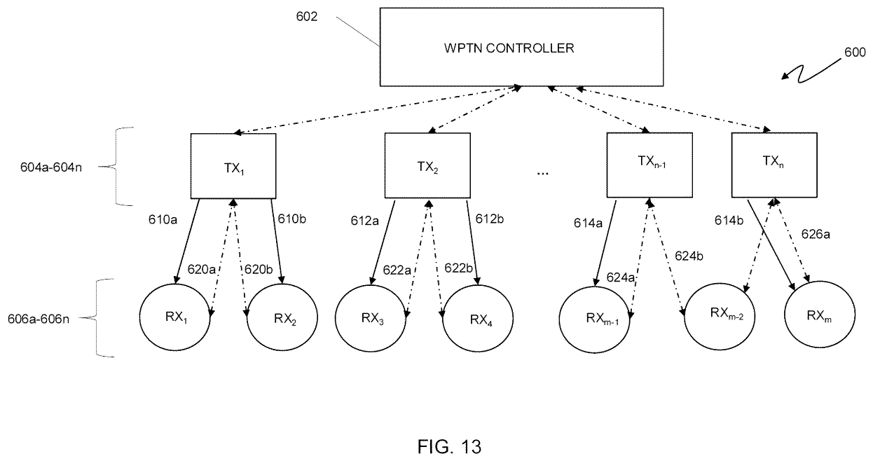

FIG. 13 shows the state of the wireless power transfer network after transmitter to receiver reassignment.

The aspects of the disclosed embodiments provide for load balancing among wireless power transmitters in a wireless power transfer network. The application layer message data structure and message sequence exchange ensures that meaningful communication can occur between devices in the wireless power transfer network so that existing and novel new management, control, and value added services can be implemented on top of it. Specific frame structures are derived from the generic frame structure to implement a specific wireless power transfer service. The application layer protocol of the disclosed embodiments is generic enough to facilitate implementation of new services in a wireless power transfer network.

Thus, while there have been shown, described and pointed out, fundamental novel features of the disclosure as applied to the exemplary embodiments thereof, it will be understood that various omissions, substitutions and changes in the form and details of devices and methods illustrated, and in their operation, may be made by those skilled in the art without departing from the spirit and scope of the disclosure. Further, it is expressly intended that all combinations of those elements, which perform substantially the same function in substantially the same way to achieve the same results, are within the scope of the disclosure. Moreover, it should be recognized that structures and/or elements shown and/or described in connection with any disclosed form or embodiment of the disclosure may be incorporated in any other disclosed or described or suggested form or embodiment as a general matter of design choice. It is the intention, therefore, to be limited only as indicated by the scope of the claims appended hereto.

What is claimed is:

1. A wireless power transfer controller in a wireless power transfer network, wherein the wireless power transfer controller comprises:
a receiver configured to receive a wireless power transfer request message for a first wireless power receiver;
a processor configured to:
determine a plurality of wireless power transmitters that are within a predetermined range of the first wireless power receiver and have a measured received signal strength indicator (RSSI) value at the first wireless power receiver above a predefined RSSI threshold value;
execute, in response to the wireless power transfer request message, a wireless power transfer load-balancing algorithm among the plurality of wireless power transmitters; and
select a first wireless power transmitter from the plurality of wireless power transmitters to serve the first wireless power receiver based upon a result of the wireless power transfer load-balancing algorithm.

2. The wireless power transfer controller of claim 1, wherein the processor is further configured to execute the wireless power transfer load-balancing algorithm by:
instructing the plurality of wireless power transmitters to transmit a wireless power signal to the first wireless power receiver;
receiving a report from the first wireless power receiver that indicates a received power from the plurality of wireless power transmitters; and
selecting the first wireless power transmitter from the plurality of wireless power transmitters based on the received power of the first wireless power transmitter and an existing wireless power transfer load on the first wireless power transmitter.

3. The wireless power transfer controller of claim 1, wherein the processor is further configured to execute the wireless power transfer load-balancing algorithm by:
mapping a measured RSSI at the first wireless power receiver to an approximate received wireless power for each of the plurality of wireless power transmitters; and
selecting the first wireless power transmitter from the plurality of wireless power transmitters based on the mapping and an existing load on the first wireless power transmitter.

4. The wireless power transfer controller of claim 1, wherein the processor is further configured to execute the wireless power transfer load-balancing algorithm based on one or more of a type of the first wireless power receiver, a priority of the first wireless power receiver, a remaining battery level of the first wireless power receiver, a battery type of the first wireless power receiver, a capacity of a battery of the first wireless power receiver, or a per unit energy requirement of the first wireless power receiver.

5. The wireless power transfer controller of claim 1, wherein the processor is further configured to:
identify a second wireless power receiver served by the first wireless power transmitter for which a power delivery requirement is not met after the first wireless power transmitter is selected to serve the first wireless power receiver;
identify at least one other wireless power transmitter within a range of the second wireless power receiver;
execute the wireless power transfer load-balancing algorithm among the at least one other wireless power transmitter to identify a second wireless power transmitter to serve the second wireless power receiver;
determine that power delivery requirements of the second wireless power receiver are not violated by assigning the second wireless power transmitter to serve the second wireless power receiver; and
select the second wireless power transmitter to serve the second wireless power receiver in response to determining that the power delivery requirements of the second wireless power receiver are not violated by assigning the second wireless power transmitter to serve the second wireless power receiver.

6. The wireless power transfer controller of claim 5, wherein the processor is further configured to further select the second wireless power transmitter to serve the second wireless power receiver by determining that assigning the second wireless power transmitter to serve the second wireless power receiver does not violate a maximum power delivery threshold of the second wireless power transmitter.

7. The wireless power transfer controller of claim 1, wherein the processor is further configured to:
receive the wireless power transfer request message from the first wireless power receiver over a communication link between the wireless power transfer controller and the first wireless power receiver; and
communicate the selection of the first wireless power transmitter together with identifying information of the first wireless power transmitter to the first wireless power receiver via the communication link.

8. The wireless power transfer controller of claim 1, wherein the processor is further configured to:
receive the wireless power transfer request message from one or more of the plurality of wireless power transmitters over a communication link between the wireless power transfer controller and the one or more of the plurality of wireless power transmitters; and
communicate the selection of the first wireless power transmitter together with identifying information of the first wireless power receiver to the first wireless power transmitter via the communication link.

9. A method for wireless power delivery in a wireless power transfer network, the method comprising:
receiving a wireless power transfer request message for a first wireless power receiver;
determining a plurality of wireless power transmitters that are within a predetermined range of the first wireless power receiver and have a measured received signal strength indicator (RSSI) value at the first wireless power receiver above a predefined RSSI threshold value;
executing, in response to the wireless power transfer request message, a wireless power transfer load-balancing algorithm among a plurality of wireless power transmitters; and
selecting a first wireless power transmitter from the plurality of wireless power transmitters to serve the first wireless power receiver based upon a result of the wireless power transfer load-balancing algorithm.

10. The method of claim 9, wherein executing the wireless power transfer load-balancing algorithm comprises:
instructing the plurality of wireless power transmitters to transmit a wireless power signal to the first wireless power receiver;
receiving a report from the first wireless power receiver that indicates a received power from the plurality of wireless power transmitters; and
selecting the first wireless power transmitter from the plurality of wireless power transmitters based on the received power of the first wireless power transmitter and an existing wireless power transfer load on the first wireless power transmitter.

11. The method of claim 9, wherein executing the wireless power transfer load-balancing algorithm comprises:
mapping a measured RSSI at the first wireless power receiver to an approximate received wireless power for each of the plurality of wireless power transmitters; and
selecting the first wireless power transmitter from the plurality of wireless power transmitters based on the mapping and an existing load on the first wireless power transmitter.

12. The method of claim 9, further comprising:
identifying a second wireless power receiver served by the first wireless power transmitter for which a power delivery requirement is not met after the first wireless power transmitter is selected to serve the first wireless power receiver;
identifying at least one other wireless power transmitter within a range of the second wireless power receiver;
executing the wireless power transfer load-balancing algorithm among the at least one other wireless power transmitter to identify a second wireless power transmitter to serve the second wireless power receiver;
determining that power delivery requirements of the second wireless power receiver are not violated by assigning the second wireless power transmitter to serve the second wireless power receiver; and
selecting the second wireless power transmitter to serve the second wireless power receiver in response to determining that the power delivery requirements of the second wireless power receiver are not violated by assigning the second wireless power transmitter to serve the second wireless power receiver.

13. The method of claim 12, wherein selecting the second wireless power transmitter to serve the second wireless power receiver further comprises determining that assigning the second wireless power transmitter to serve the second wireless power receiver does not violate a maximum power delivery threshold of the second wireless power transmitter.

14. The method of claim 9, further comprising:
receiving the wireless power transfer request message from the first wireless power receiver over a communication link between a wireless power transfer controller and the first wireless power receiver; and
communicating the selection of the first wireless power transmitter together with identifying information of the first wireless power transmitter to the first wireless power receiver via the communication link.

15. The method of claim 9, further comprising:
receiving the wireless power transfer request message from one or more of the wireless power transmitters over a communication link between a wireless power transfer controller and the one or more wireless power transmitters; and
communicating the selection of the first wireless power transmitter together with identifying information of the first wireless power receiver to the first wireless power transmitter via the communication link.

16. A wireless power transfer network comprising:
a first wireless power receiver;
a plurality of wireless power transmitters; and
a wireless power transfer controller configured to:
receive a wireless power transfer request message for the first wireless power receiver;
determine the plurality of wireless power transmitters that are within a predetermined range of the first wireless power receiver and have a measured received signal strength indicator (RSSI) value at the first wireless power receiver above a predefined RSSI threshold value;
execute, in response to the wireless power transfer request message, a wireless power transfer load-balancing algorithm among the plurality of wireless power transmitters; and
select a first wireless power transmitter from the plurality of wireless power transmitters to serve the first wireless power receiver based upon a result of the execution of the wireless power transfer load-balancing algorithm.

17. The wireless power transfer network of claim 16, wherein the wireless power transfer controller is further configured to execute the wireless power transfer load-balancing algorithm by:
instructing the plurality of wireless power transmitters to transmit a wireless power signal to the first wireless power receiver;
receiving a report from the first wireless power receiver that indicates a received power from the plurality of wireless power transmitters; and
selecting the first wireless power transmitter from the plurality of wireless power transmitters based on a received power of the first wireless power transmitter and an existing wireless power transfer load on the first wireless power transmitter.

18. The wireless power transfer network of claim 16, wherein the wireless power transfer controller is further configured to execute the wireless power transfer load-balancing algorithm by:
mapping a measured RSSI at the first wireless power receiver to an approximate received wireless power for each of the plurality of wireless power transmitters; and
selecting the first wireless power transmitter from the plurality of wireless power transmitters based on the mapping and an existing load on the first wireless power transmitter.

19. The wireless power transfer network of claim 16, wherein the wireless power transfer controller is further configured to execute the wireless power transfer load-balancing algorithm based on one or more of a type of the first wireless power receiver, a priority of the first wireless power receiver, a remaining battery level of the first wireless power receiver, a battery type of the first wireless power receiver, a capacity of a battery of the first wireless power receiver, and a per unit energy requirement of the first wireless power receiver.

20. The wireless power transfer network of claim 16, wherein the wireless power transfer controller is further configured to:
identify a second wireless power receiver served by the first wireless power transmitter for which a power delivery requirement is not met after the first wireless power transmitter is selected to serve the first wireless power receiver;
identify at least one other wireless power transmitter within a range of the second wireless power receiver;
execute the wireless power transfer load-balancing algorithm among the at least one other wireless power transmitter to identify a second wireless power transmitter to serve the second wireless power receiver;
determine that power delivery requirements of the second wireless power receiver are not violated by assigning the second wireless power transmitter to serve the second wireless power receiver; and
select the second wireless power transmitter to serve the second wireless power receiver in response to determining that the power delivery requirements of the second wireless power receiver are not violated by assigning the second wireless power transmitter to serve the second wireless power receiver.
